(19) United States
(12) Patent Application Publication
(10) Pub. No.: US 2023/0322099 A1
(43) Pub. Date: Oct. 12, 2023

(54) ELECTRIC VEHICLE AND PAD ASSEMBLY WITH COMPOSITE TYPE MAGNETIC COMPLEX MATERIAL

(71) Applicant: SKC Co., Ltd., Suwon-si (KR)

(72) Inventors: Na Young KIM, Anseong-si (KR); Jonghak CHOI, Uiwang-si (KR); Seung Hwan LEE, Seoul (KR); Jong Hwi PARK, Suwon-si (KR); Tae Kyoung KIM, Seoul (KR)

(73) Assignee: SKC Co., Ltd., Suwon-si (KR)

(21) Appl. No.: 18/334,536

(22) Filed: Jun. 14, 2023

Related U.S. Application Data
(63) Continuation of application No. PCT/KR2021/016115, filed on Nov. 8, 2021.

(30) Foreign Application Priority Data
Jan. 12, 2021 (KR) 10-2021-0003726

(51) Int. Cl. B60L 53/12; H01F 27/24; H01F 27/28

(52) U.S. Cl. CPC B60L 53/12; H01F 27/24; H01F 27/28

(57) ABSTRACT

A pad assembly for power reception of an electric vehicle includes a receiving pad configured to support a receiving coil connected to an external component, and a magnetic complex layer disposed above or below the receiving coil. An increment in inductance per unit density of the magnetic complex layer disposed above or below the receiving coil is 25%·cm³/g or more compared to an increment in inductance per unit density of the magnetic complex layer alone not disposed above or below the receiving coil.

### CROSS-REFERENCE TO RELATED APPLICATIONS

This application is a U.S. national stage application of International Patent Application No. PCT/KR2021/016115, filed on Nov. 8, 2021, which claims the benefit of Korean Patent Application No. 10-2021-0003726, filed on Jan. 12, 2021, in the Korean Intellectual Property Office, the entire disclosures of which are incorporated herein by reference for all purposes.

### BACKGROUND

### 1. Field

The present disclosure relates to an electric vehicle and pad assembly with composite type magnetic complex material.

### 2. Discussion of Related Art

Electric transportation charging systems can be basically defined as systems for charging a battery installed in electric transportation using a commercial power grid or the power of an energy storage device. Electric transportation charging systems can have various forms according to the type of electric transportation. For example, an electric transportation charging system may include a conductive charging system using a cable or a non-contact wireless power transmission system. Generally, wireless power charging by the wireless power transmission system is a method of charging a battery using a current flowing through electromagnetic induction, in which a magnetic field generated by a current flowing in a primary coil of a charger generates an induced current in a secondary coil of the battery, and then the induced current charges the battery with chemical energy. This technique is as safe as a wired charging method because a contact point is not exposed, and thus there is almost no risk of a short circuit.

As electric transportation has become popular, there has been a growing interest in building charging infrastructure. Various charging methods are already appearing, such as electric transportation charging using household chargers, battery replacement, rapid charging devices, and wireless charging devices.

As the spread of electric transportation, such as electric vehicles, is expected to increase in the future, a safe and fast charging method that shortens charging time and increases convenience is desired. Accordingly, a wireless power charging method that can solve the inconvenience of a wired charging method used by inserting a plug into an outlet and various techniques for securing charging efficiency and safety through wireless charging is on the rise.

Impact resistance and charging efficiency of the wireless power charging part are more important in that an impact that may occur due to an accident in electric transportation is large and affects the safety of an occupant of the electric transportation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a pad assembly for power reception of an electric vehicle includes a receiving pad configured to support a receiving coil connected to an external component, and a magnetic complex layer disposed above or below the receiving coil. An increment in inductance per unit density of the magnetic complex layer disposed above or below the receiving coil is 25%·cm³/g or more compared to an increment in inductance per unit density of the magnetic complex layer alone not disposed above or below the receiving coil.

The increment in inductance per unit density of the magnetic complex layer disposed above or below the receiving coil may be 50%·cm³/g or less compared to the increment in inductance per unit density of the magnetic complex layer alone not disposed above or below the receiving coil.

The magnetic complex layer may include particles of magnetic powder bonded to each other by a polymer resin, and a magnetic complex material having elongation at break of 0.5% or more.

The magnetic complex layer may include a stacked structure including a magnetic complex material including magnetic powder particles bonded to each other by a polymer resin, and a nanocrystalline grain magnetic body.

The magnetic complex material may have a Q factor change rate ranging from 0 to 5% before and after a free fall impact from a height of 1 m.

The magnetic complex material may include 20 to 150 sheets of the magnetic complex material.

The nanocrystalline grain magnetic body may include one or more selected from the group consisting of an Fe—Si—Al-based nanocrystalline magnetic body, an Fe—Si—Cr-based nanocrystalline magnetic body, and an Fe—Si—B—Cu—Nb-based nanocrystalline magnetic body.

The magnetic complex material and the nanocrystalline grain magnetic body included in the magnetic complex layer may be applied at a thickness ratio of 1:0.0001 to 5.

An increment in resistance per unit density of the magnetic complex layer disposed above or below the receiving coil may be 40.0%·cm³/g or less compared to an increment in resistance per unit density of the magnetic complex layer alone not disposed above or below the receiving coil.

The pad assembly may have a charging efficiency of 85% or more in response to the magnetic complex layer having a thickness of 5 mm being applied to the receiving pad having a size of 35.5 cm×35.5 cm.

An electric vehicle may include the pad assembly above.

In another general aspect, a pad assembly for power reception of an electric vehicle includes a receiving pad configured to support a receiving coil connected to an external component, and a magnetic complex layer disposed above or below the receiving coil. A charging efficiency per unit density of the magnetic complex layer disposed above or below the receiving coil is 19%·cm³/g or more compared to a charging efficiency per unit density of the magnetic complex layer alone not disposed above or below the receiving coil.

The charging efficiency per unit density of the magnetic complex layer disposed above or below the receiving coil may be 30%·cm³/g or less compared to the charging efficiency per unit density of the magnetic complex layer alone not disposed above or below the receiving coil.

The magnetic complex layer may include a stacked structure including a magnetic complex material containing magnetic powder particles bonded to each other by a polymer resin, and a nanocrystalline grain magnetic body.

An increment in resistance per unit density of the magnetic complex layer disposed above or below the receiving coil may be 40.0%·cm³/g or less compared to an increment in resistance per unit density of the magnetic complex layer alone not disposed above or below the receiving coil.

An electric vehicle may include the pad assembly of above.

Other features and aspects will be apparent from the following detailed description, the drawings, and the claims.

### BRIEF DESCRIPTION OF THE DRAWINGS

FIG. 1 illustrates an example of a wireless power receiving device for wireless charging of an electric vehicle according to one or more embodiments.

FIG. 2 is a perspective view illustrating an example of a wireless power receiving device for electric vehicle wireless charging according to one or more embodiments.

FIG. 3 is a perspective view depicting an example of a magnetic complex layer disposed in a pad assembly according to one or more embodiments.

FIG. 4 is a conceptual diagram depicting a cross section of an example of a hybrid magnetic complex layer structure according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Throughout the present specification, the expression “X increment of a pad assembly after assembly compared to before assembly” means that “X value of the pad assembly assembled to include a magnetic complex layer arranged in the pad assembly” of an embodiment is represented in a percentage % based on “X value of the pad assembly before assembly.”

In the case of a power transmission/reception module applied to transportation vehicles electrically driven, e.g., a receiving module in the vehicle, stability is desirable, and unlike a receiving module applied to a portable electronic device, the power transmission/reception module may directly receive an impact applied to the transportation or noise caused by the transportation. The inventors of the present disclosure contemplated a method of improving physical properties by considering that, when a magnetic sheet included in the receiving module is damaged due to impact, the power receiving efficiency of the receiving module may be significantly reduced, and the magnetic sheet should have excellent physical properties within a predetermined size and volume.

Electric transportation may be, for example, transportation using electricity as a main power source, such as an electric car, an electric bus, an electric motorcycle, an electric bicycle, or an electric kickboard.

The present disclosure is directed to a receiving part for generating an induced current by a power supply positioned outside electric transportation to charge a battery corresponding to power of the electric transportation and is directed to providing a composite type magnetic complex for charging electric transportation, which has excellent physical properties and sufficient impact resistance to be applicable to a vehicle, and electric transportation including the same.

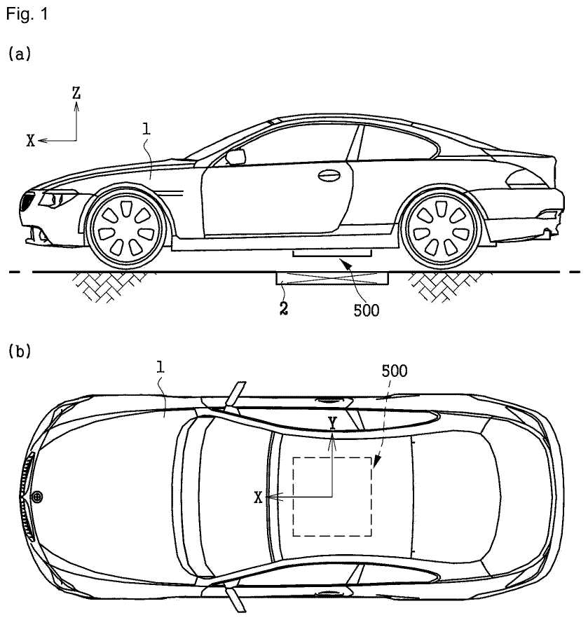

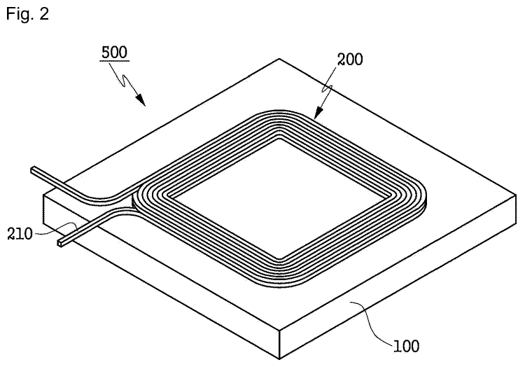

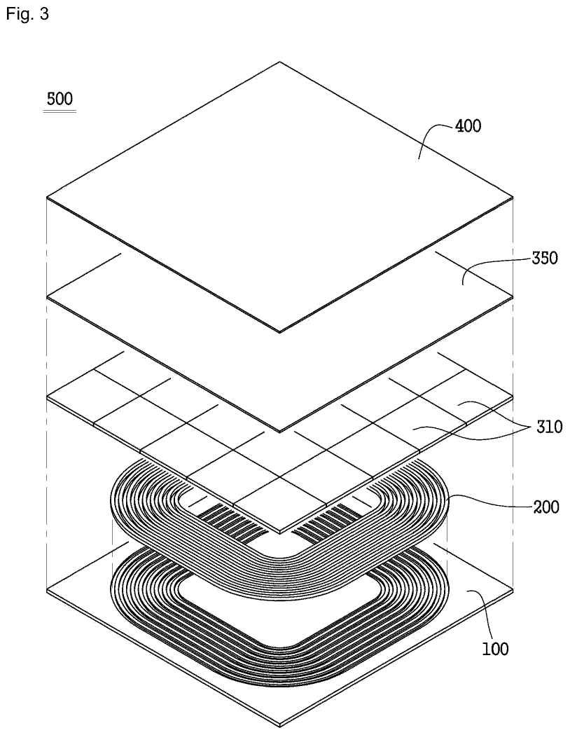

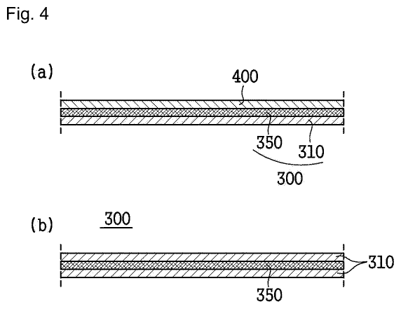

(a) and (b) of FIG. 1 are diagrams illustrating an example of a wireless power receiving device for wireless charging of an electric vehicle according to one or more embodiments. FIG. 2 is a perspective view illustrating an example of a wireless power receiving device for wireless charging of the electric vehicle according to one or more embodiments. FIG. 3 is a perspective view depicting an example of a magnetic complex layer disposed in a pad assembly according to one or more embodiments. In addition, (a) and (b) of FIG. 4 are conceptual diagrams of a cross section of an example of a hybrid magnetic complex layer structure according to one or more embodiments. Hereinafter, embodiments will be described in more detail with reference to FIGS. 1 to 4.

A pad assembly 500 for power reception of an electric vehicle 1, according to one or more embodiments, includes a receiving pad 100 for supporting a receiving coil 200, the receiving coil 200 connected to an external component through a wire 210 and positioned on the receiving pad 100, and a magnetic complex layer 300 disposed above or below the receiving coil 200.

In the pad assembly 500, an increment in inductance per unit density of the magnetic complex layer in the pad assembly 500 after assembly may be 25%·cm³/g or more compared to before assembly, which may mean that a magnetic focusing force is excellent, and charging efficiency can be further improved by applying the magnetic complex layer having the above characteristic to the pad assembly.

The magnetic complex layer 300 may include i) a magnetic complex material 310 or ii) a stacked structure including the magnetic complex material 310 and a nanocrystalline grain magnetic body 350.

The magnetic complex material 310 includes particles of magnetic powder bonded to each other by a polymer resin.

The magnetic complex material 310 may be in the form of a sheet with a predetermined area or a block with a predetermined area and thickness.

The magnetic complex layer 300 for an electric vehicle may be included in a relatively large area of the charging pad assembly 500 for an electric vehicle. In one or more embodiments, the magnetic complex layer 300 may be included in an area of 200 cm² or more, in an area of 400 cm² or more, or in an area of 600 cm² or more. Alternatively, the magnetic complex layer 300 for an electric vehicle may be included in an area of 10,000 cm² or less. In the large-area magnetic complex layer 300, a method of arranging a plurality of magnetic complex materials may be applied. In this case, each magnetic complex material 310 may have an area of 60 cm² or more, an area of 90 cm², or an area ranging from 95 cm² to 900 cm².

As described above, when particles of the magnetic powder are bonded to each other by a polymer resin, a magnetic complex material with fewer defects and less damage due to external impact over a large area may be developed.

The magnetic complex material 310 for an electric vehicle may have an elongation at a break of 0.5% or more. The magnetic complex material with the above elongation at break has a characteristic that is difficult to obtain in a ceramic-based magnetic complex material to which a polymer is not applied, and even when distortion occurs in a large-area magnetic complex due to external impact, the large-area magnetic complex can reduce damage to the magnetic sheet itself.

In one or more embodiments, the elongation at the break of the magnetic complex material for electric vehicles may be 0.5% or more, 1% or more, or 2.5% or more. However, there is no particular limitation on an upper limit of the elongation at break, and when the content of the polymer resin is increased to improve the elongation at break, since physical properties such as inductance of the magnetic complex may be degraded, the elongation at break may be 10% or less.

The magnetic complex material 310 for an electric vehicle has a desired feature in which a physical property change before and after an impact is relatively small.

In one or more embodiments, the magnetic complex material 310 for an electric vehicle may have an inductance change rate of less than 5%, and 3% or less before and after a free fall impact from a height of 1 m. The inductance change rate is 0%, with no substantial change before and after the impact. In one or more embodiments, the inductance change rate of the magnetic complex for an electric vehicle before and after a free fall impact from a height of 1 m may range from 0 to 3%, from 0.001 to 2%, or from 0.01 to 1.5%. The magnetic complex material for an electric vehicle with the above inductance change rate may have a relatively small inductance change rate before and after the impact to provide a magnetic complex with improved stability.

A change rate in the Q factor of the magnetic complex material 310 for an electric vehicle before and after a free fall impact from a height of 1 m may range from 0 to 5%, from 0.001 to 4%, or from 0.01 to 2.5%. These values are far superior results compared to those of a ferrite magnetic sheet, and this means that the stability and impact resistance of the magnetic complex are further improved because the change in the physical property before and after the impact is relatively small.

A resistance change rate of the magnetic complex material 310 for an electric vehicle before and after a free fall impact from a height of 1 m may range from 0 to 2.8%, from 0.001 to 1.8%, or from 0.1 to 1.0%. These values are far superior results compared to those of a ferrite magnetic sheet, and since a change of a resistance value before and after the impact is relatively small, even when the magnetic complex is repeatedly applied in an environment where an impact and a vibration are actually applied, the magnetic complex has a characteristic that the resistance value is maintained well below a predetermined level.

A reduction ratio in charging efficiency of the magnetic complex material 310 for an electric vehicle before and after a free fall impact from a height of 1 m may range from 0 to 6.8%, from 0.001 to 5.8%, or from 0.01 to 3.4%. The reduction ratio in charging efficiency means that the charging efficiency decreases to a very small extent even after the impact, which may mean that the magnetic complex applied in a relatively large area may provide stable physical properties even when an impact or distortion occurs repeatedly.

The charging efficiency is a result evaluated at a frequency of less than 100 kHz, for example, 85 kHz, and is evaluated in a frequency band distinguished from a frequency band applied to portable electronic devices such as mobile phones.

The magnetic complex material 310 for an electric vehicle may be in the form of a block and may have a thickness of 1 mm or more, 2 mm or more, 3 mm or more, or 4 mm or more. Alternatively, the block-shaped magnetic complex material 310 for an electric vehicle may have a thickness of 6 mm or less. The block-shaped magnetic complex may be manufactured by injection molding or the like and has an advantage of being manufactured with a relatively thick thickness.

The magnetic complex material 310 for an electric vehicle may be in the form of a sheet and may have a thickness of 80 μm or more or a thickness ranging from 85 μm to 150 μm. A conventional method of manufacturing a film or a sheet may be applied to manufacture the magnetic complex material in the form of a sheet, which has the advantage of enabling the magnetic complex material to be manufactured with an intended area and size with an excellent yield.

When sheet-shaped magnetic complex materials in the form of a sheet are stacked and applied to the magnetic complex material 310 for an electric vehicle, the magnetic complex material 310 may be 20 or more stacked sheet-shaped magnetic complex materials, or 50 or more stacked sheet-shaped magnetic complex materials. The magnetic complex material 310 may be 150 or less stacked sheet-shaped magnetic complex materials, or 100 or more stacked sheet-shaped magnetic complex materials.

The polymer resin may be cured, and the magnetic complex material 310 may contain 85 wt % or more magnetic powder. In one or more embodiments, the magnetic complex material may include 85 to 99 wt % or 88 to 99 wt % magnetic powder.

The magnetic complex material 310 for an electric vehicle may have permeability ranging from 20 to 150,000 in a frequency band of less than 100 kHz. For example, the magnetic complex material 310 for an electric vehicle may have permeability ranging from 20 to 150,000 at a frequency of 85 kHz.

In one or more embodiments, the magnetic complex material 310 for an electric vehicle may have permeability ranging from 30 to 300 in a frequency band of less than 100 kHz. For example, the magnetic complex material 310 for an electric vehicle may have permeability ranging from 30 to 300 at a frequency of 85 kHz.

In one or more embodiments, the magnetic complex material 310 for an electric vehicle may have permeability ranging from 600 to 3,500 in a frequency band of less than 100 kHz. For example, the magnetic complex material 310 for an electric vehicle may have permeability ranging from 600 to 3,500 at a frequency of 85 kHz.

In one or more embodiments, the magnetic complex material 310 for an electric vehicle may have permeability ranging from 10,000 to 150,000 in a frequency band of less than 100 kHz. For example, the magnetic complex material 310 for an electric vehicle may have permeability ranging from 10,000 to 150,000 at a frequency of 85 kHz.

The magnetic complex material 310 contains a magnetic powder. The magnetic powder may be a metal magnetic powder containing permalloy, sendust, or Fe—Si—Al-based, Fe—Si—Cr-based, or Fe—Si—B—Cu—Nb-based nanocrystalline structure or a mixed powder thereof.

The Fe—Si—B—Cu—Nb-based nanocrystalline structure is a nanocrystalline structure containing 70 to 85 mol % of Fe, 10 to 29 mol % of Si and B, and 1 to 5 mol % of Cu and Nb and includes, for example, Fe_{73.5}CuNb₃Si_{13.5}B₉. Higher shielding performance can be obtained when the nanocrystalline structure is included in the metal magnetic powder.

The particle diameter of the magnetic powder may range from 3 nm to 1 mm.

The magnetic complex material 310 may have heat resistance with which the magnetic complex material 310 can withstand a high temperature condition, and corrosion resistance with which the magnetic complex material 310 can withstand various corrosive environments.

A curable resin may be used as a polymer resin into which the magnetic powder is mixed, and in one or more embodiments, may include a photocurable resin, a thermosetting resin, and a highly heat-resistant thermoplastic resin. The curable resin may include, for example, a polyurethane-based resin, acrylic resin, polyester resin, isocyanate resin, or epoxy resin, but the present disclosure is not limited thereto.

In one or more embodiments, the polymer resin may include a polyurethane-based resin, an isocyanate-based curing agent, and an epoxy-based resin.

The polyurethane-based resin may have an average molecular weight of about 500 to 50,000 g/mol, about 10,000 to 50,000 g/mol, or about 10,000 to 40,000 g/mol.

The isocyanate-based curing agent may be an organic diisocyanate.

For example, the isocyanate-based curing agent may be an aromatic diisocyanate, an aliphatic diisocyanate, a substituted diisocyanate, or a mixture thereof.

The epoxy-based resin may include bisphenol type epoxy resins such as a bisphenol A type epoxy resin, a bisphenol F type epoxy resin, a bisphenol S type epoxy resin, and a tetrabromobisphenol A type epoxy resin; glycidyl ether type epoxy resins such as spiro cyclic epoxy resin, a naphthalene type epoxy resin, a biphenyl type epoxy resin, a terpene type epoxy resin, tris(glycidyloxyphenyl)methane, and tetrakis(glycidyloxyphenyl)ethane; a glycidyl amine type epoxy resin such as tetraglycidyl diaminodiphenylmethane; a cresol novolak type epoxy resin; and novolak-type epoxy resins such as a phenol novolak-type epoxy resin, an α-naprol novolak-type epoxy resin, and a brominated phenol novolak-type epoxy resin. A single type of these epoxy-based resins or a combination of two or more types may be used.

The magnetic complex material 310 may include a 1 to 15 wt % or 1 to 12 wt % polymer resin.

Alternatively, the magnetic complex material 310 may include a 75 to 85 wt % polyurethane-based resin, a 10 to 18 wt % isocyanate-based curing agent, and a 3 to 10 wt % epoxy-based resin based on the total weight of the polymer resin (the remaining amount is a magnetic powder). When a polymer resin with the above-described composition is applied as the polymer resin, it is possible to provide a magnetic complex that is easier to manufacture and has excellent physical properties.

The magnetic complex material 310 may be manufactured through a sheeting process of mixing a magnetic powder and a polymer resin composition into a slurry, forming the slurry into a sheet shape, and curing (thermally curing) the slurry, but in order to manufacture a large-area magnetic complex having a predetermined thickness, a composite block may be manufactured by injection molding. A conventional sheeting or blocking method may be applied as the sheeting or blocking method in the manufacturing process, and a detailed method is not particularly limited.

The nanocrystalline grain magnetic body 350 includes a nanocrystalline magnetic body or soft magnetic body. For example, an Fe—Si—Al-based nanocrystalline magnetic body, an Fe—Si—Cr-based nanocrystalline magnetic body, or an Fe—Si—B—Cu—Nb-based nanocrystalline magnetic body may be applied as the nanocrystalline grain magnetic body 350, but the present disclosure is not limited thereto. In one or more embodiments, a Fe—Si—B—Cu—Nb-based nanocrystalline structure is a nanocrystalline structure containing 70 to 85 mol % of Fe, 10 to 29 mol % of Si and B, and 1 to 5 mol % of Cu and Nb and includes, for example, Fe_{73.5}CuNb₃Si_{13.5}B₉. When the nanocrystalline grain magnetic body 350 and the magnetic complex material 310 are stacked and applied, a more excellent inductance increase effect of the pad can be achieved.

When the magnetic complex layer 300 includes a stacked structure of the magnetic complex material 310 and the nanocrystalline grain magnetic body 350, the magnetic complex layer 300 has an advantage in that impact resistance is improved by the magnetic complex and an increment in inductance is improved by the nanocrystalline magnetic body. In addition, the magnetic complex layer 300 has an advantage of additionally obtaining effects of significantly increasing the increment in inductance compared to a unit density of the magnetic complex layer, reducing an increment in resistance, and reducing weight and improving charging efficiency when a predetermined volume of magnetic complex layer is applied, which are difficult to obtain simultaneously.

The magnetic complex material 310 and the nanocrystalline grain magnetic body 350 included in the magnetic complex layer 300 may be applied at a thickness ratio of 1:0.0001 to 5. When the thickness ratio is less than 1:0.0001, an effect of stacking the nanocrystalline grain magnetic body can be substantially insignificant, and when the thickness ratio exceeds 1:5, cost efficiency can decrease.

In one or more embodiments, the magnetic complex material 310 and the nanocrystalline grain magnetic body 350 included in the magnetic complex layer 300 may be applied at a thickness ratio of 1:0.01 to 1, 1:0.01 to 0.5, 1:0.02 to 0.1, or 1:0.03 to 0.7. When the magnetic complex and the nanocrystalline grain magnetic body are applied together within the above ranges, a pad assembly having a faster charging speed can be provided.

An increment in inductance per unit density of the magnetic complex layer in the pad assembly 500 after assembly may be 25%·cm³/g or more, 30%·cm³/g or more, 35.5%·cm³/g or more, or 37%·cm³/g or more compared to before assembly. In the pad assembly 500, the increment in inductance per unit density of the magnetic complex layer in the pad assembly 500 after assembly may be 50%·cm³/g or less or 45%·cm³/g compared to before assembly. The increment in inductance is higher than or equal to that of ferrite with a relatively heavy weight, is significantly improved compared to the case of applying only the magnetic complex itself, and is an excellent physical property obtained at an improved level even in impact resistance.

An increment in resistance per unit density of the magnetic complex layer in the pad assembly 500 after assembly may be 40.0%·cm³/g or less, 30%·cm³/g or less, 26.0%·cm³/g or less, or 20.0%·cm³/g or less compared to before assembly. In addition, in the pad assembly 500, the increment in resistance of the pad assembly 500 after assembly compared to before assembly may have a negative value and may be −20%·cm³/g or more. The increase in resistance is a result of significantly reducing a resistance value which increases when the nanocrystalline grain magnetic body is applied and is considered an excellent physical property obtained by applying the magnetic complex and the nanocrystalline grain magnetic body together.

Charging efficiency per unit density of the magnetic complex layer in the pad assembly 500 after assembly may be 19%·cm³/g or more or 20%·cm³/g or more compared to before assembly. Alternatively, the charging efficiency per unit density of the magnetic complex layer in the pad assembly 500 after assembly may be 30%·cm³/g or less or 25%·cm³/g or less compared to before assembly. The increase in charging efficiency results from significantly improving the charging efficiency by the magnetic complex layer, especially when the pad assembly is applied in a limited condition of the predetermined volume and area.

The charging efficiency of the pad assembly 500 may be 85% or more, 89% or more, 99% or less, or 95% or less based on the application of the magnetic complex layer 300 with a 5 mm thickness to a 35.5 cm×35.5 cm receiving pad to which a coil and a frame with SAE J2954 WPT2 Z2 Class standard TEST standard are applied.

The increment in resistance of the pad assembly 500 may be 200% or less or 150% or less, and may have a negative value of −80% or more based on the application of the magnetic complex layer 300 with a 5 mm thickness to a 35.5 cm×35.5 cm receiving pad to which a coil and a frame with SAE J2954 WPT2 Z2 Class standard TEST standard are applied.

The increment in inductance of the pad assembly 500 may be 150% or more based on the application of the magnetic complex layer 300 with a 5 mm thickness to a 35.5 cm×35.5 cm receiving pad to which a coil and a frame with SAE J2954 WPT2 Z2 Class standard TEST standard are applied.

An electric vehicle 1, according to another embodiment, includes the above-described pad assembly 500 for power reception of the electric vehicle. Descriptions of the pad assembly and the magnetic complex included therein overlap with the above descriptions, and thus the descriptions thereof will be omitted. The pad assembly 500 serves as a receiving part for wireless charging of an electric vehicle and allows efficient charging of the electric vehicle together with a power supply 2.

Hereinafter, the embodiments will be described in more detail through specific examples. The following examples are merely illustrative to aid understanding of the present disclosure, and the scope of the present disclosure is not limited by the following examples.

### 1. Manufacturing Example

Materials of Magnetic Complex

Materials used in the following examples are as follows.
Magnetic powder: sandust powder (C1F-02A by Crystallite Technology)
Polyurethane resin: UD1357 by Daiichi Seika Co., Ltd.
Isocyanate-based curing agent: isophorone diisocyanate by Sigma-Aldrich
Epoxy resin: bisphenol A type epoxy resin (epoxy equivalent=189 g/eq) (Epikote™ 828 by Japan Epoxy Resin)
Nylon resin: nylon 12 (3020 by Ubesta) and nylon 6 (B40 by BASF)
PP resin: 5030 by Korea Petrochemical Ind. Co., LTD.

### Example 1: Manufacturing of Composite-Type Magnetic Complex

Step 1) Preparation of Magnetic Powder Slurry

A magnetic powder slurry was prepared by mixing 42.8 parts by weight of a magnetic powder, 15.4 parts by weight of a polyurethane-based resin dispersion (25 wt % polyurethane-based resin and 75 wt % 2-butanone), 1.0 part by weight of an isocyanate-based curing agent dispersion (62 wt % isocyanate-based curing agent, 25 wt % n-butyl acetate, and 13 wt % 2-butanone), 0.4 parts by weight of an epoxy resin dispersion (70 wt % epoxy resin, 3 wt % n-butyl acetate, 15 wt % 2-butanone, and 12 wt % toluene), and 40.5 parts by weight of toluene in a planetary mixer at a speed of about 40 to 50 rpm for about two hours.

Step 2) Manufacturing of Composite-Type Magnetic Sheet

A carrier film was coated with the previously prepared magnetic powder slurry using a comma coater and dried at a temperature of about 110° C. to form a dried magnetic complex. The dried magnetic complex was compressed and cured by a hot press process at a temperature of about 170° C. and a pressure of about 9 Mpa for about 60 minutes to obtain a sheet-shaped magnetic complex. The content of the magnetic powder of the manufactured magnetic complex was about 90%, and the thickness of one sheet was about 100 μm. 40 to 50 sheets were stacked to form a magnetic complex with a thickness of about 4.8 mm, and then a test was performed on the magnetic complex.

### Example 2: Manufacturing of Hybrid Magnetic Sheet

A hybrid-type magnetic sheet (with a thickness of 5 mm) of Example 2 was manufactured by arranging a nanocrystalline grain magnetic body sheet (with a thickness of 0.2 mm and manufactured by Hitachi, Ltd.) on one side of the composite type magnetic sheet (with the thickness of 4.8 mm) manufactured in Example 1 and by thermocompression bonding the nanocrystalline grain magnetic body sheet.

### Comparative Example 1: Ferrite Magnetic Sheet

A PC-95 ferrite magnetic sheet (with a thickness of 5 mm) from TDK Corporation was used.

### Comparative Example 2: Magnetic Sheet of Nanocrystalline Grain Magnetic Body

Magnetic sheets of a nanocrystalline grain magnetic body from SKC Co., Ltd. were stacked to a thickness of 5 mm and used.

### 2. Evaluation of Physical Properties of Magnetic Complex

The physical properties of the magnetic sheets of the examples and comparative examples were evaluated by the following methods, and the results are shown in a table.

### 1) Evaluation of Physical Properties of Composite-Type Magnetic Sheet

The physical properties of the composite-type magnetic sheet of Example 1 and the ferrite of Comparative Example 1 were compared using the following method.

Method of Applying Impact

Samples of the examples and comparative examples were dropped from a height of 1 m and an impact was applied thereto.

Evaluation of Elongation at Break

Elongation at break was measured using a UTM device (INSTRON 5982 by INSTRON (Illinois Tool Works Inc.)) and was measured only for a sheet of 70 μm before the impact was applied according to ASTM D412 Type C.

Evaluation of Inductance Change Rate

An inductance change rate was measured using an LCR Meter (IM3533 manufactured by Hioki Co.) by measuring inductance before and after the application of the impact and calculating the change rate using the following equation 1.

inductance change rate=100×(inductance before impact−inductance after impact)/(inductance before impact) Equation 1:

Evaluation of Resistance Change Rate and Q Factor Change Rate

A resistance change rate was measured using the LCR Meter (IM3533 by Hioki Co.) by measuring inductance before and after the application of the impact and calculating the change rate using the following equation 2.

resistance change rate=100×(resistance before impact−resistance after impact)/(resistance before impact) Equation 2:

In addition, the Q factor change rate was calculated using Equation 3.

Q factor change rate=100×(Q factor value before impact−Q factor value after impact)/(Q factor before impact) Equation 3:

Here, Q factor=(inductance×frequency×2π/resistance)

Evaluation of the Degree of Reduction in Charging Efficiency

The charging efficiency was calculated using the following equation 4 for each of the cases of the sheet before and after the impact, and the charging efficiency was measured in a condition of an output power of 1000 W and a frequency of 85 kHz.

reduction in charging efficiency=100×(charging efficiency before impact−charging efficiency after impact)/(charging efficiency before impact) Equation 4:

For all measurements, SAE J2954 WPT1 Z2 Class standard TEST standard coil and frame were applied, and a receiving pad (35.5 cm×35.5 cm) and a transmitting pad (67.48 cm×59.1 cm) were manufactured by stacking magnetic bodies, spacers, and aluminum plates and measured at a frequency of 85 kHz.

TABLE 1

| | Impact | Elongation | | Q | Resist- | Charging |
|---|---|---|---|---|---|---|
| | application | at break | Inductance | factor | ance | efficiency |
| Compar- | Before | 0 | 230 | 481 | 263 | 94 |
| ative | After | 0 | 218 | 414 | 290 | 91 |
| Example | | | | | | |
| 1 | | | | | | |
| Example | Before | 3% | 225 | 444 | 279 | 93 |
| 1 | After | 3% | 225 | 442 | 280 | 93 |

TABLE 2

| | Elongation | Inductance | Q factor | Resistance | Reduction in |
|---|---|---|---|---|---|
| | at | change | change | change | charging |
| (%) | break | amount | rate | rate | efficiency |
| Comparative | 0 | 5.2 | 14 | 10.3 | 3 |
| Example 1 | | | | | |
| Example 1 | 3 | 0 | 0.36 | 0.36 | 0 |

Referring to the results of Table 1, it can be confirmed that, when the sheet of Example 1 having an average value of elongation at break of 3% is compared with the sheet of Comparative Example 1, which is a ferrite sheet, each of the change rates of the factors such as the inductance, the Q factor, and the resistance before and after the impact ranged from 0 to 1 so that only a very slight change appeared before and after the impact was applied. On the other hand, in the sheet of Comparative Example 1, the change rates of the factors such as the inductance, the Q factor, and the resistance appeared at significant levels. The average value of the reduction in charging efficiency appeared as high as 3%, and it was confirmed that the charging efficiency of the sheet of Comparative Example 1 was significantly reduced by the application of impact. Consequently, it was confirmed that the sheet of Example 1 was more excellent for stable application as a receiving pad of a wireless charger in an environment where an impact is easily applied to an electric vehicle during traveling.

2) Evaluation of Physical Properties of Hybrid Sheet

After assembling the samples of the examples and comparative examples with a magnetic body, changes in the inductance and charging efficiency were measured. The assembly of the magnetic body proceeded in the same way as in the evaluation of physical properties in 1), and the thicknesses of all sheets were 5 mm.

Evaluation of Increment in Inductance

The increment in inductance was calculated by measuring inductance before assembling the magnetic body using the LCR Meter (IM3533 by Hioki Co.) and measuring the inductance of a pad in which the magnetic bodies of the examples and comparative examples were stacked.

Evaluation of Increment in Resistance

The increment in resistance was calculated by measuring resistance before assembling the magnetic body using the LCR Meter (IM3533 by HIOKI Co.) and measuring the resistance of the pad in which the magnetic bodies of the examples and comparative examples were stacked.

Density Measurement

The total density of the manufactured magnetic body was calculated based on volume and weight and is shown in the following Table 3.

Charging Efficiency Evaluation 1

The charging efficiency was measured using SAE J2954 WPT2 Z2 Class standard TEST. SAE J2954 WPT2 Z2 Class standard TEST standard coil and frame were applied, and a receiving pad (35.5 cm×35.5 cm) and a transmitting pad (75 cm×60 cm) were manufactured by stacking magnetic bodies, spacers, and aluminum plates and measured in the same condition of the output power of 6 kW at a frequency of 85 kHz.

TABLE 3

| | | | | | Increment | Increment | |
|---|---|---|---|---|---|---|---|
| | | | | | in | in | Charging |
| | Increment | Increment | | | inductance | resistance | efficiency |
| | in | in | Charging | | per unit | per unit | per unit |
| | inductance | resistance | efficiency | Density | density | density | density |
| | (%) | (%) | (%) | (g/cm3) | (% · cm3/g)* | (% · cm3/g)* | (% · cm3/g)* |
| Comparative | 169 | −13 | 91 | 4.81 | 35.14 | −2.70 | 18.92 |
| Example 1 | | | | | | | |
| Comparative | 175 | 425 | 91 | 7.13 | 24.54 | 59.61 | 12.76 |
| Example 2 | | | | | | | |
| Example 1 | 156 | −19 | 89 | 4.32 | 36.11 | −4.40 | 20.60 |
| Example 2 | 167 | 113 | 91 | 4.38 | 38.13 | 25.80 | 20.78 |

Increment in inductance per unit density=(increment in inductance)/(density of magnetic complex layer), * increment in resistance per unit density=(increment in resistance)/(density of magnetic complex layer), and * increment in charging efficiency per unit density per unit density=(charging efficiency)/(density of magnetic complex layer)

Referring to the results of Table 3, it was confirmed that, in the case of Comparative Example 2, to which the nanocrystalline grain magnetic body was applied, the charging efficiency was excellent, but the increment in resistance was significantly increased. In addition, it was also confirmed that, in the case of Comparative Example 2 to which the ferrite was applied, the increase in inductance and the charging efficiency were excellent, but the weight increased when applied to the same volume because the density was rather large.

In the case of the composite sheet of Example 1, the density was low, and thus the weight of the same volume was relatively light, the increment in inductance per unit density was excellent, and the increment in resistance was also a negative value and had an excellent characteristic. In the case of Example 2, the increase in inductance was excellently evaluated at a level similar to that of the ferrite or the nanocrystalline grain magnetic body itself, and the density was also evaluated lower than that of the ferrite as well as the nanocrystalline grain magnetic body and thus had an excellent physical property. However, the increment in resistance per unit density was slightly lowered compared to Example 1, but due to the characteristic of the receiving pad mounted in the electric vehicle, there is a practical limit to the size of the receiving pad itself and the volume that the magnetic complex layer can occupy. In terms of application to a predetermined volume, Example 2 was experimentally confirmed to enable higher charging efficiency than Example 1 to be obtained.

Embodiments of the present disclosure usefully provide a hybrid composite type magnetic complex with excellent impact resistance suitable for wireless charging of electric vehicles, a pad assembly including the hybrid composite type magnetic complex, and an electric vehicle including the pad assembly. The magnetic complex has excellent impact resistance, is light in weight, and enables wireless charging with excellent charging efficiency when applied to the pad assembly applied to a power receiving part. In addition, according to the embodiments, excellent charging efficiency can be maintained well even when an impact or repetitive vibration is applied to the pad assembly.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A pad assembly for power reception of an electric vehicle, the pad assembly comprising:
a receiving pad configured to support a receiving coil connected to an external component; and
a magnetic complex layer disposed above or below the receiving coil,
wherein an increment in inductance per unit density of the magnetic complex layer disposed above or below the receiving coil is 25%·cm³/g or more compared to an increment in inductance per unit density of the magnetic complex layer alone not disposed above or below the receiving coil.

2. The pad assembly of claim 1, wherein the increment in inductance per unit density of the magnetic complex layer disposed above or below the receiving coil is 50%·cm³/g or less compared to the increment in inductance per unit density of the magnetic complex layer alone not disposed above or below the receiving coil.

3. The pad assembly of claim 1, wherein the magnetic complex layer comprises particles of magnetic powder bonded to each other by a polymer resin, and a magnetic complex material having elongation at break of 0.5% or more.

4. The pad assembly of claim 1, wherein the magnetic complex layer comprises a stacked structure including a magnetic complex material comprising magnetic powder particles bonded to each other by a polymer resin, and a nanocrystalline grain magnetic body.

5. The pad assembly of claim 4, wherein the magnetic complex material has a Q factor change rate ranging from 0 to 5% before and after a free fall impact from a height of 1 m.

6. The pad assembly of claim 4, wherein the magnetic complex material comprises 20 to 150 sheets of the magnetic complex material.

7. The pad assembly of claim 4, wherein the nanocrystalline grain magnetic body includes one or more selected from the group consisting of an Fe—Si—Al-based nanocrystalline magnetic body, an Fe—Si—Cr-based nanocrystalline magnetic body, and an Fe—Si—B—Cu—Nb-based nanocrystalline magnetic body.

8. The pad assembly of claim 4, wherein the magnetic complex material and the nanocrystalline grain magnetic body included in the magnetic complex layer are applied at a thickness ratio of 1:0.0001 to 5.

9. The pad assembly of claim 1, wherein an increment in resistance per unit density of the magnetic complex layer disposed above or below the receiving coil is 40.0%·cm³/g or less compared to an increment in resistance per unit density of the magnetic complex layer alone not disposed above or below the receiving coil.

10. The pad assembly of claim 1, wherein the pad assembly has a charging efficiency of 85% or more in response to the magnetic complex layer having a thickness of 5 mm being applied to the receiving pad having a size of 35.5 cm×35.5 cm.

11. An electric vehicle comprising the pad assembly of claim 1.

12. A pad assembly for power reception of an electric vehicle, the pad assembly comprising:
a receiving pad configured to support a receiving coil connected to an external component; and
a magnetic complex layer disposed above or below the receiving coil,
wherein a charging efficiency per unit density of the magnetic complex layer disposed above or below the receiving coil is 19%·cm³/g or more compared to a charging efficiency per unit density of the magnetic complex layer alone not disposed above or below the receiving coil.

13. The pad assembly of claim 12, wherein the charging efficiency per unit density of the magnetic complex layer disposed above or below the receiving coil is 30%·cm³/g or less compared to the charging efficiency per unit density of the magnetic complex layer alone not disposed above or below the receiving coil.

14. The pad assembly of claim 12, wherein the magnetic complex layer comprises a stacked structure including a magnetic complex material containing magnetic powder particles bonded to each other by a polymer resin, and a nanocrystalline grain magnetic body.

15. The pad assembly of claim 12, wherein an increment in resistance per unit density of the magnetic complex layer disposed above or below the receiving coil is 40.0%·cm³/g or less compared to an increment in resistance per unit density of the magnetic complex layer alone not disposed above or below the receiving coil.

16. An electric vehicle comprising the pad assembly of claim 12.
